(19) United States
(12) Patent Application Publication
(10) Pub. No.: US 2025/0053031 A1
(43) Pub. Date: Feb. 13, 2025

(54) Optical Device

(71) Applicant: Nippon Telegraph and Telephone Corporation, Tokyo (JP)

(72) Inventor: Hidetaka Nishi, Musashino-shi, Tokyo (JP)

(21) Appl. No.: 18/721,940

(22) PCT Filed: Dec. 22, 2021
(86) PCT No.: PCT/JP2021/047533

§ 371 Date: Jun. 20, 2024

(51) Int. Cl. G02F 1/035; G02F 1/03

(52) U.S. Cl. CPC G02F 1/035; G02F 1/0305

(57) ABSTRACT

An optical device includes a slab layer formed on a lower cladding layer, a core formed on the slab layer, a first metal layer, and a second metal layer. The optical device further includes a first adhesion layer and a second adhesion layer formed between the slab layer on both sides of the core and the first metal layer and the second metal layer. The first metal layer and the second metal layer are formed apart from the core.

### TECHNICAL FIELD

The present invention relates to an optical device using an electro-optic material.

### BACKGROUND ART

Optical waveguide type high-speed phase shifters have been researched and developed as key devices for various applications that use Tbit/s-class ultra-high-speed optical communication and millimeter or terahertz waves. Of such high-speed phase shifters, there is a plasmonic optical waveguide type phase shifter using an electro-optic (EO) material for an optical waveguide core.

Of the optical waveguide type high-speed phase shifters, the plasmonic optical waveguide type phase shifter has an operation principle of dielectric response by an external modulated electric field in order to cause a change in a refractive index, and has a large mode overlap between a modulated high-frequency signal and waveguide propagation light, and can have an extremely short element length. Therefore, according to the above-described technology, an ultra-small and ultra-low capacitance phase shifter that can be regarded as a lumped constant element for a modulated high-frequency signal can be implemented, and an optical modulator that can operate at a high speed can be implemented.

In the above-described plasmonic optical waveguide type phase shifter, a metallic outer conductor of the plasmonic optical waveguide is formed. Finally, an EO polymer which is an organic material is applied to fill minute gaps interposed between the metallic outer conductors with the EO material, and thus a core made of the EO material is formed.

However, the EO material of the above-described core is limited to a material that can be formed to fill minute gaps in a back-end process. On the other hand, as an inorganic material that has been widely used as the EO material, a high-quality material can be obtained by a crystal growth technique under a special environment such as a high temperature. However, it is difficult to form a high-quality crystal so that minute gaps are filled after a metallic outer conductor is formed, as described above.

Due to the above-described problem, when an EO material that is an inorganic material is used, a technique for first forming a core and then forming a metallic outer conductor as follows can be applied (Non Patent Literature 1). In this technique, first, as illustrated in FIG. 3A, a wafer including an Si layer 302 on an SiO₂ layer 301 serving as a lower cladding is prepared. Subsequently, the Si layer 302 is patterned to form a rib-shaped core 303 as illustrated in FIG. 3B.

Subsequently, as illustrated in FIG. 3C, an Al layer 304 is formed on the Si layer 302 on which the core 303 is formed to cover the core 303. Thereafter, the Al layer 304 on the upper surface of the core 303 is removed, for example, by selectively thinning the Al layer 304 to expose the upper surface of the core 303, as illustrated in FIG. 3D. As a result, a plasmonic optical waveguide including the core 303 formed to fill the minute gaps of the Al layers 304a and 304b serving as metallic outer conductors is manufactured.

### CITATION LIST

### Non Patent Literature

Non Patent Literature 1: H. Nishi et al., “High-speed Si plasmonic photodetector based on internal photoemission and two-photon absorption”, Conference on Lasers and Electro-Optics, 18024143, 2018.

### SUMMARY OF INVENTION

### Technical Problem

Incidentally, in this type of plasmonic optical waveguide, the metallic outer conductor is generally made of Au in order to reduce a loss. However, since Au has low adhesion with a layer of the EO material forming the rib-shaped waveguide, an adhesion layer is introduced therebetween. However, when the adhesion layer is between the outer conductor made of Au and the core, characteristics of the plasmonic optical waveguide are greatly affected by the adhesion layer, and thus there is a large problem that it is difficult to reduce the original expected loss using Au.

The present invention has been devised to solve the foregoing problems, and an object of the present invention is to reduce a loss even when an adhesion layer is introduced between a layer of an electro-optic material and a metallic outer conductor.

### Solution to Problem

According to an aspect of the present invention, an optical device includes: a slab layer made of an electro-optic material having an electro-optic effect; a core formed on the slab layer and made of the same electro-optic material as the slab layer; first and second metal layers each formed in contact with both side surfaces of the core; and an adhesion layer formed between the slab layer on both sides of the core and the first and second metal layers and formed to improve adhesion between the slab layer and the first and second metal layers. The electro-optic material is an inorganic material. The first and second metal layers are made of a noble metal. The core, the first metal layer, and the second metal layer form a plasmonic optical waveguide.

### Advantageous Effects of Invention

As described above, according to the present invention, since the adhesion layer is formed between the slab layers on both sides of the core and the first and second metal layers, it is possible to achieve a reduction in the loss even when the adhesion layer is introduced between the layer of the electro-optic material and the metallic outer conductor.

### BRIEF DESCRIPTION OF DRAWINGS

FIG. 1 is a cross-sectional view illustrating a configuration of an optical device according to an embodiment of the present invention.

FIG. 2A is a cross-sectional view illustrating a state of the optical device in an intermediate step to describe a method of manufacturing the optical device according to the embodiment of the present invention.

FIG. 2B is a cross-sectional view illustrating a state of the optical device in an intermediate step to describe the method of manufacturing the optical device according to the embodiment of the present invention.

FIG. 2C is a cross-sectional view illustrating a state of the optical device in an intermediate step to describe the method of manufacturing the optical device according to the embodiment of the present invention.

FIG. 3D FIG. 2D is a cross-sectional view illustrating a state of the optical device in an intermediate step to describe the method of manufacturing the optical device according to the embodiment of the present invention.

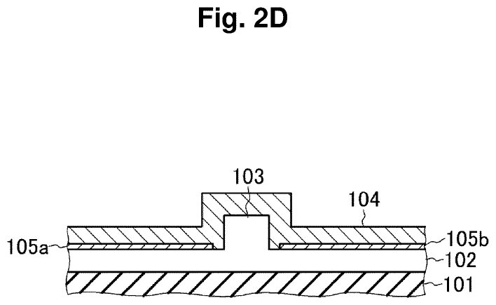

FIG. 3A is a cross-sectional view illustrating a state of the optical device in an intermediate step to describe the method of manufacturing the optical device.

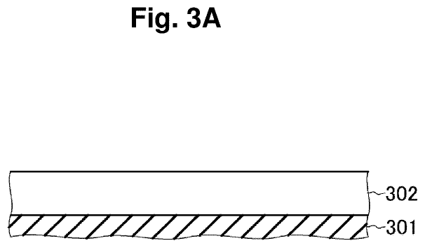

FIG. 3B is a cross-sectional view illustrating a state of the optical device in an intermediate step to describe the method of manufacturing the optical device.

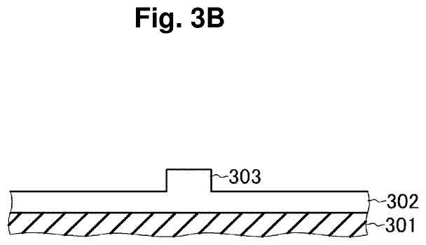

FIG. 3C is a cross-sectional view illustrating a state of the optical device in an intermediate step to describe the method of manufacturing the optical device.

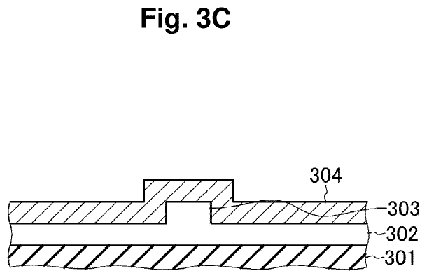

FIG. 3D is a cross-sectional view illustrating a state of the optical device in an intermediate step to describe the method of manufacturing the optical device.

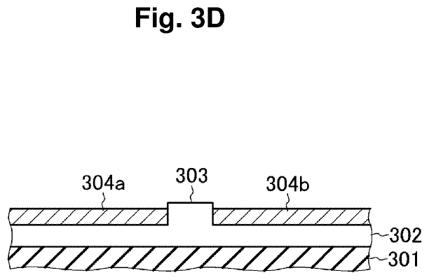

### DESCRIPTION OF EMBODIMENTS

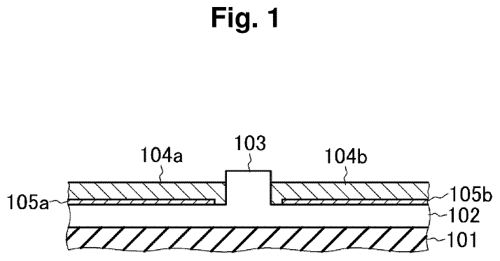

Hereinafter, an optical device according to an embodiment of the present invention will be described with reference to FIG. 1. The optical device includes a slab layer 102 formed on the lower cladding layer 101, a core 103 formed on the slab layer 102, a first metal layer 104a, and a second metal layer 104b. The slab layer 102 is made of an electro-optic material having an electro-optic effect, and the core 103 is also made of the same electro-optic material as the slab layer 102.

The slab layer 102 and the core 103 form a rib-shaped waveguide that has the core 103 as a rib. The slab layer 102 and the core 103 can be integrated. The first metal layer 104a and the second metal layer 104b are formed on the slab layer 102 in contact with both side surfaces of the core 103. The first metal layer 104a and the second metal layer 104b are not formed above the core 103. The core 103, the first metal layer 104a, and the second metal layer 104b form a plasmonic optical waveguide. An upper cladding layer made of an insulating material can be provided on the core 103, the first metal layer 104a, and the second metal layer 104b. In this example, air is used as the upper cladding.

Further, the optical device includes a first adhesion layer 105a and a second adhesion layer 105b formed between the slab layers 102 on both sides of the core 103 and the first metal layer 104a and the second metal layer 104b. The first adhesion layer 105a and the second adhesion layer 105b are used to improve adhesion between the slab layer 102, and the first metal layer 104a and the second metal layer 104b. The first metal layer 104a and the second metal layer 104b are formed apart from the core 103.

The lower cladding layer 101 can be made of, for example, an insulating material such as SiO₂. The electro-optic material of the slab layer 102 and the core 103 is an inorganic material, and can be, for example, at least one of lithium niobate, lithium tantalate, barium titanate, or potassium niobate tantalate.

The first metal layer 104a and the second metal layer 104b can be made of, for example, a noble metal such as gold (Au) or silver (Ag). By forming the first metal layer 104a and the second metal layer 104b from these metals, it is possible to achieve a reduction in a loss of the plasmonic optical waveguide. The first adhesion layer 105a and the second adhesion layer 105b can be made of Cr or Ti.

For example, a thickness (total core height) from a bottom surface of the slab layer 102 to an upper surface of the core 103 can be set to 200 nm, and a width of the core 103 can be set to 50 nm in a cross-sectional view. The thickness of the slab layer 102 can be set to 100 nm. The first metal layer 104a and the second metal layer 104b can have a thickness of 80 nm. The first adhesion layer 105a and the second adhesion layer 105b can be separated from the side surfaces of the core 103 by 40 nm.

According to the above-described embodiment, since the first adhesion layer 105a and the second adhesion layer 105b are provided, peeling of the first metal layer 104a and the second metal layer 104b is inhibited, and contact between the side surface of the core 103 and the first metal layer 104a and the second metal layer 104b is maintained. As is well known, for example, adhesion between Cr and lithium niobate is good, and adhesion between Cr and Au is good. Accordingly, the first adhesion layer 105a and the second adhesion layer 105b can prevent peeling of the first metal layer 104a and the second metal layer 104b. Since areas of the first adhesion layer 105a and the second adhesion layer 105b are sufficiently large compared to a sensation between the first adhesion layer 105a and the second adhesion layer 105b, and the side surface of the core 103, an adhesion layer is not formed in a contact portion between the core 103, and the first metal layer 104a and the second metal layer 104b, but peeling of the first metal layer 104a and the second metal layer 104b can be sufficiently prevented.

Since the first adhesion layer 105a and the second adhesion layer 105b are separated from the side surface of the core 103, characteristics of the plasmonic optical waveguide are not affected by the first adhesion layer 105a and the second adhesion layer 105b. In this way, according to the embodiment, even when the first adhesion layer 105a and the second adhesion layer 105b are introduced between the slab layer 102, and the first metal layer 104a and the second metal layer 104b, the reduction in the loss can be achieved.

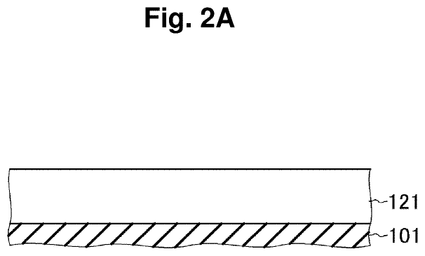

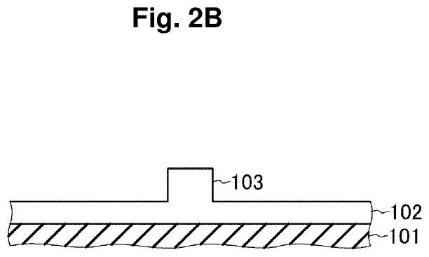

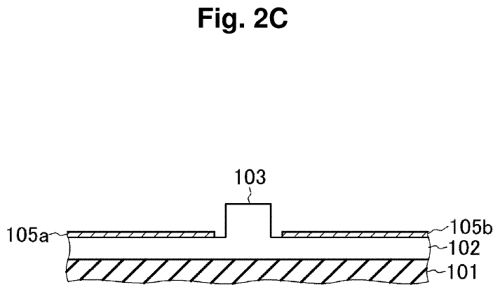

Next, manufacturing of an optical device according to an embodiment of the present invention will be described with reference to FIGS. 2A to 2D.

First, as illustrated in FIG. 2A, a wafer including an LN film 121 made of lithium niobate on the lower cladding layer 101 made of SiO₂ is prepared. Subsequently, the LN film 121 is patterned by dry etching using a hard mask formed by an electron beam lithography technique to form the rib-shaped core 103 on the slab layer 102, as illustrated in FIG. 1B.

Subsequently, as illustrated in FIG. 1C, the first adhesion layer 105a and the second adhesion layer 105b made of Cr are formed on the slab layers 102 on both sides of the core 103. The first adhesion layer 105a and the second adhesion layer 105b are formed to be separated from the side surface (skirt) of the core 103 by 40 nm. For example, a lift-off mask covering a portion of the core 103 is first formed by an electron beam lithography technique. Subsequently, Cr is deposited from above the lift-off mask by electron beam evaporation or the like. Thereafter, the lift-off mask is removed (lifted off) to form the first adhesion layer 105a and the second adhesion layer 105b.

Subsequently, as illustrated in FIG. 2D, the Au layer 104 is formed to cover the core 103, the first adhesion layer 105a, and the second adhesion layer 105b. Thereafter, the Au layer 104 on the upper surface of the core 103 is removed by selectively thinning the Au layer 104 or the like, and the upper surface of the core 103 is exposed, as illustrated in FIG. 1. For example, a step difference on the upper surface of the Au layer 104 by the core 103 is first flattened by a resist film formed by applying a resist made of an organic material. Subsequently, etching back is performed from the surface of the flattened resist film to expose a protrusion portion of the upper surface of the Au layer 104 by the core 103. Thereafter, when the Au layer 104 above the core 103 is removed by a predetermined dry etching technique, the upper surface of the core 103 can be exposed.

As described above, according to the present invention, the adhesion layer is formed between the slab layers on both sides of the core and the first metal layer and the second metal layer. Therefore, even when the adhesion layer is introduced between the layer of the electro-optic material and the metallic outer conductor, the reduction in the loss can be achieved.

According to the present invention, the problem of adhesion to the layer of the electro-optic material can be solved even when the metallic outer conductor is made of a noble metal such as Au, which has a small value of the imaginary part of the complex dielectric constant among metals having a real part of a negative complex dielectric constant and is expected to implement a low-loss plasmonic optical waveguide. It is possible to solve the problem that the metallic outer conductor is peeled not only in the case of the reduction in the loss of the plasmonic optical waveguide but also in the case of a combination of materials from the viewpoint of increasing a speed and improving efficiency of the plasmonic optical waveguide modulator.

The present invention is not limited to the foregoing embodiments, and it should be apparent to those skilled in the art that modifications and combinations can be made without departing from the scope of the present invention.

### REFERENCE SIGNS LIST

101 Lower cladding layer
102 Slab layer
103 Core
104a First metal layer
104b second metal layer
105a First adhesion layer
105b Second adhesion layer

1. An optical device comprising:
a slab layer made of an electro-optic material having an electro-optic effect;
a core formed on the slab layer and made of the same electro-optic material as the slab layer;
first and second metal layers each formed in contact with both side surfaces of the core; and
an adhesion layer formed between the slab layer on both sides of the core and the first and second metal layers and formed to improve adhesion between the slab layer and the first and second metal layers,
wherein the electro-optic material is an inorganic material,
wherein the first and second metal layers are made of a noble metal, and
wherein the core, the first metal layer, and the second metal layer form a plasmonic optical waveguide.

2. The optical device according to claim 1, wherein the electro-optic material is at least one of lithium niobate, lithium tantalate, barium titanate, or potassium niobate tantalate.

3. The optical device according to claim 1, wherein the first and second metal layers are made of Au or Ag.

4. The optical device according to claim 1, wherein the adhesion layer is made of Cr or Ti.

5. The optical device according to claim 1, wherein the first and second metal layers are formed apart from the core.

6. The optical device according to claim 1, wherein the slab layer and the core are integrated.

7. The optical device according to claim 2, wherein the first and second metal layers are made of Au or Ag.

8. The optical device according to claim 2, wherein the adhesion layer is made of Cr or Ti.

9. The optical device according to claim 3, wherein the adhesion layer is made of Cr or Ti.

10. The optical device according to claim 2, wherein the first and second metal layers are formed apart from the core.

11. The optical device according to claim 3, wherein the first and second metal layers are formed apart from the core.

12. The optical device according to claim 4, wherein the first and second metal layers are formed apart from the core.

13. The optical device according to claim 2, wherein the slab layer and the core are integrated.

14. The optical device according to claim 3, wherein the slab layer and the core are integrated.

15. The optical device according to claim 4, wherein the slab layer and the core are integrated.

16. The optical device according to claim 5, wherein the slab layer and the core are integrated.
